(19) United States
(12) Patent Application Publication
(10) Pub. No.: US 2021/0157538 A1
(43) Pub. Date: May 27, 2021

(54) IMAGE FORMING APPARATUS AND RECORDING MEDIUM

(71) Applicant: Mitsuo NAKAMURA, Tokyo (JP)

(72) Inventor: Mitsuo NAKAMURA, Tokyo (JP)

(73) Assignee: Ricoh Company, Ltd., Tokyo (JP)

(21) Appl. No.: 17/097,321

(22) Filed: Nov. 13, 2020

(30) Foreign Application Priority Data
Nov. 21, 2019 (JP) 2019-210552

(51) Int. Cl. G06F 3/12

(52) U.S. Cl. CPC G06F 3/1273; G06F 3/1204; G06F 3/1287; G06F 3/1256

(57) ABSTRACT

An image forming apparatus includes processing circuitry; and a memory storing computer-executable instructions that cause the processing circuitry to transmit, to a server, log information that represents a content of a log that is created according to a job type of a job of the image processing apparatus; and transmit, to the server, customization information obtained by customizing a folder name of a folder included in the server that is a storage destination of the log information or by customizing a file name of a file including the log information, the folder name or the file name being customized based on customization instruction information that represents an instruction to customize the folder name or the file name.

### CROSS-REFERENCE TO RELATED APPLICATION

The present application is based on and claims priority under 35 U.S.C. § 119 to Japanese Patent Application No. 2019-210552, filed on Nov. 21, 2019, the contents of which are incorporated herein by reference in their entirety.

### BACKGROUND OF THE INVENTION

### 1. Field of the Invention

The present invention relates to an image forming apparatus and a recording medium.

### 2. Description of the Related Art

Patent Document 1 discloses a technology for preventing the leakage of confidential information, personal information, and the like included in a log, even when a server for collecting and managing print history or the like is installed on the Internet. In the technique disclosed in Patent Document 1, when a print job is generated, identification information specifying the transmission destination of a job log is added to the print job, so that it is possible to select either a server on an intranet or a server on the Internet as the storage destination of the job log.

Patent Document 1: Japanese Unexamined Patent Application Publication No. 2012-68725

### SUMMARY OF THE INVENTION

According to one aspect of the present invention, there is provided an image forming apparatus including processing circuitry; and a memory storing computer-executable instructions that cause the processing circuitry to transmit, to a server, log information that represents a content of a log that is created according to a job type of a job of the image processing apparatus; and transmit, to the server, customization information obtained by customizing a folder name of a folder included in the server that is a storage destination of the log information or by customizing a file name of a file including the log information, the folder name or the file name being customized based on customization instruction information that represents an instruction to customize the folder name or the file name.

### BRIEF DESCRIPTION OF THE DRAWINGS

FIG. 1 is a diagram illustrating a configuration of an information processing system including an image forming apparatus according to an embodiment of the present invention;

FIG. 2 is a diagram illustrating a hardware configuration of the image forming apparatus according to an embodiment of the present invention;

FIG. 3 is a functional block diagram of an image forming apparatus according to an embodiment of the present invention;

FIG. 4A illustrates an example of a screen for selecting a device to be managed by a management tool according to an embodiment of the present invention;

FIG. 4B illustrates an example of an icon displayed on the home screen of an operation unit of an image forming apparatus according to an embodiment of the present invention;

FIG. 4C illustrates an example of a screen for executing the setting reflection of a log collection according to an embodiment of the present invention;

FIG. 4D illustrates an example of warning dialog according to an embodiment of the present invention;

FIG. 5A illustrates an example of a screen for customizing a folder according to an embodiment of the present invention;

FIG. 5B illustrates an example of a screen for setting folder elements according to an embodiment of the present invention;

FIG. 5C is a diagram for explaining elements that can be set at the time of folder customization according to an embodiment of the present invention;

FIG. 5D illustrates an example of a screen for customizing a file according to an embodiment of the present invention;

FIG. 5E is a diagram for explaining elements that can be set at the time of file customization according to an embodiment of the present invention;

FIG. 6A is a diagram for explaining the operation of the information processing system at the time of log transmission according to an embodiment of the present invention;

FIG. 6B is a sequence chart for explaining an operation of an image forming apparatus according to an embodiment of the present invention;

FIG. 7 is a first flowchart explaining a character number determination operation according to an embodiment of the present invention;

FIG. 8 is a second flowchart explaining the character number determination operation according to an embodiment of the present invention;

FIG. 9 is a third flowchart explaining the character number determination operation according to an embodiment of the present invention;

FIG. 10 is a fourth flowchart explaining the character number determination operation according to an embodiment of the present invention;

FIG. 11 is a diagram illustrating the contents of a report mail according to an embodiment of the present invention;

FIG. 12 is a fifth flowchart explaining the character number determination operation according to an embodiment of the present invention;

FIG. 13 is a diagram illustrating an example of an operation log according to an embodiment of the present invention;

FIG. 14 is a sixth flowchart explaining the character number determination operation according to an embodiment of the present invention; and

FIG. 15 is a diagram illustrating an example of a log retransmission screen according to an embodiment of the present invention.

### DETAILED DESCRIPTION OF THE PREFERRED EMBODIMENTS

In the conventional technology, it is possible to select the storage destination for storing a log; however, the user needs to search for the storage destination for storing the log, and, therefore, there is scope for improvement in the operability when searching for a log.

A problem to be addressed by an embodiment of the present invention is to improve the operability when searching for a log.

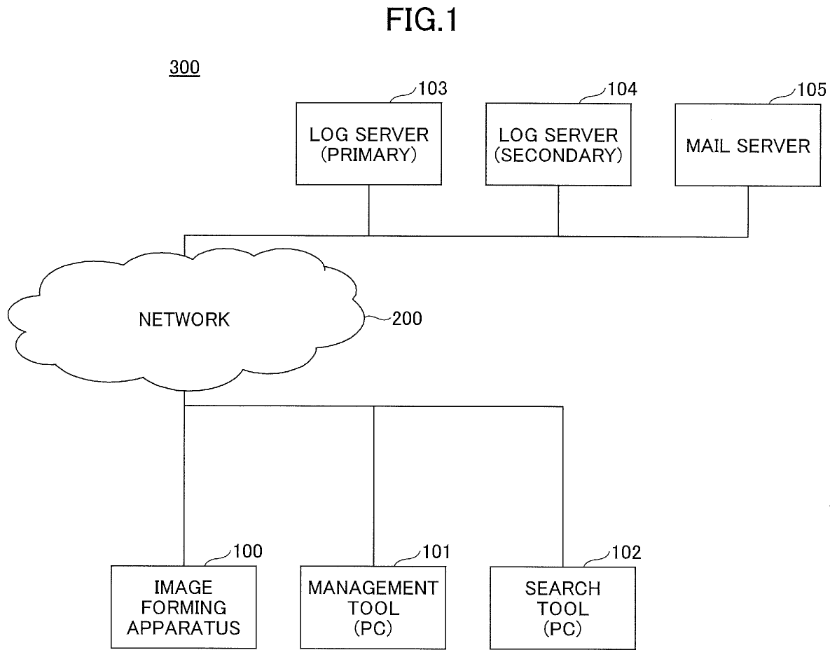

Hereinafter, an embodiment for carrying out the present invention will be described with reference to the drawings. FIG. 1 is a diagram illustrating a configuration of an information processing system including an image forming apparatus according to the present embodiment. An information processing system 300 includes an image forming apparatus 100, a management tool 101, a search tool 102, a log server 103 (primary) for managing a log, a log server 104 (secondary) for managing a log, and a mail server 105.

The management tool 101 is a tool for managing devices connected to a network 200. The management tool 101 is software implemented by an exclusive-use program being executed by an information processing apparatus that is a user terminal, such as a personal computer, operated by the device administrator or a user of the image forming apparatus 100. The management tool 101 makes a setting, to the image forming apparatus 100, for storing an image log and a job log in the log server 103.

Specifically, the management tool 101 customizes a folder path of the log server 103 and a file path and sets the customized folder path and the customized file path to the image forming apparatus 100. The folder path is a folder name of a folder that stores a log acquired in the image forming apparatus 100, in the log server 103. The file path is a file name used for storing a log acquired in the image forming apparatus 100, in the log server 103. Customization means to set the folder path of the log server 103 to any content desired by the user, and to set the file path to any content desired by the user. As described above, by using the management tool 101, it is possible to set one of the folders set in the log server 103 as a folder for storing an image log and a job log acquired in the image forming apparatus 100, and to set the file name of the log to be stored. Further, the image log and the job log are stored in the log server 103 with a folder name and a file name which are easy for the user to identify, and, therefore, the operability when searching for the storage destination file of the log can be improved by using the search tool 102.

An image log is created, for example, by converting the image data handled when the image forming apparatus 100 has executed the job, into a multi-page PDF file, so that the image data can be extracted as a log. A job log is an eXtensible Markup Language (XML) file in which the job condition and the result of the job when the job is executed by the image forming apparatus 100 are recorded. The image forming apparatus 100 is a multifunction peripheral, a copier, a scanner, a facsimile machine, a printer, or the like connected to the network 200. The network 200 may be the Internet, intranet, or the like. The network 200 is not limited to the Internet, the intranet, or the like, and may be any relevant communication network capable of transmitting information.

The log server 104 is a backup server. The mail server 105 is a server for reporting, to the administrator, the log processing state by mail.

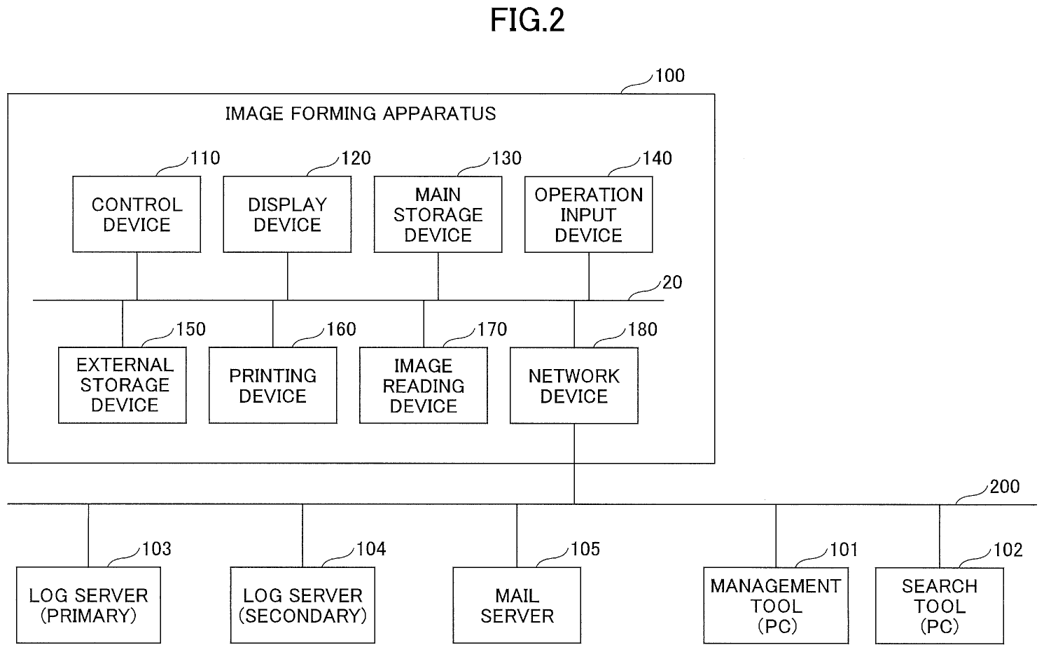

Next, the hardware configuration of the image forming apparatus 100 will be described with reference to FIG. 2. FIG. 2 is a diagram illustrating a hardware configuration of an image forming apparatus. The image forming apparatus 100 includes a control device 110, a display device 120, a main storage device 130, an operation input device 140, an external storage device 150, a printing device 160, an image reading device 170, and a network device 180.

The main storage device 130 includes a Random Access Memory (RAM) or the like that functions as a work area of a program executed by the control device 110. The external storage device 150, for example, is a hard disk drive and stores various control programs, application programs, image data, and the like. The control device 110 loads and executes the necessary programs from the external storage device 150 to the main storage device 130 and controls the entire image forming apparatus 100 via a bus 20. The control device 110 performs processing for implementing, for example, functions of a multifunction peripheral, a copier, a scanner, a facsimile machine, a printer, or the like, in the image forming apparatus 100. The operation input device 140 is a user interface that accepts an operation of a user and provides information to a user by displaying information corresponding to the operation on a screen not illustrated in the drawing. The network device 180 is a communication interface that connects the image forming apparatus 100 to the network 200.

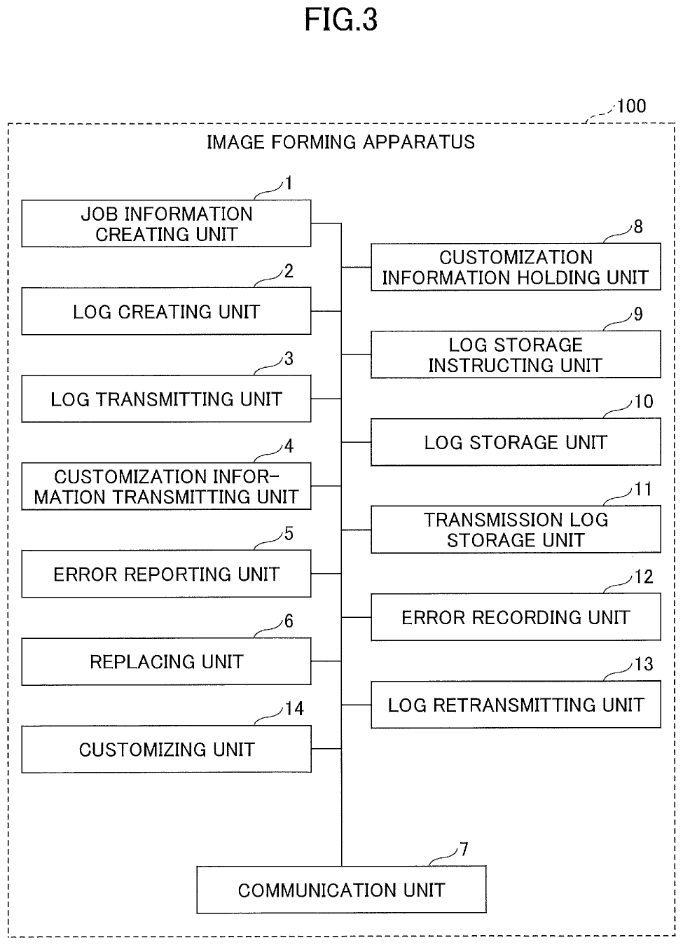

Next, the functions of the image forming apparatus 100 will be described with reference to FIG. 3. FIG. 3 is a functional block diagram of the image forming apparatus. The image forming apparatus 100 includes a job information creating unit 1, a log creating unit 2, a log transmitting unit 3, a customization information transmitting unit 4, an error reporting unit 5, a replacing unit 6, a communication unit 7, and a customization information holding unit 8. Further, the image forming apparatus 100 includes a log storage instructing unit 9, a log storage unit 10, a transmission log storage unit 11, an error recording unit 12, a log retransmitting unit 13, and a customizing unit 14.

The log storage instructing unit 9 is a function that makes settings for collecting image logs, for example, to the image reading device 170 and the printing device 160 illustrated in FIG. 2, and gives instructions to store image logs, and job logs in the external storage device 150.

The job information creating unit 1 is a function that creates job information representing the type of the executed job and inputs the job information to the log creating unit 2.

The log creating unit 2 is a function for creating a log corresponding to the job type based on the job information and storing the created log in the log storage unit 10.

The log transmitting unit 3 acquires a log stored in the log storage unit 10 and creates a transmission log (log information) which is a log to be transmitted to the log server 103, based on the acquired log. The log transmitting unit 3 stores the created transmission log in the transmission log storage unit 11 and also transmits the created transmission log to the log server 103. The transmission log storage unit 11 is a storage unit that temporarily stores the transmission log.

The customizing unit 14 creates customization information obtained by customizing a log stored in the log storage unit 10 based on customization instruction information. Specifically, the customizing unit 14 performs a process of changing (customizing) the file name of a file in which the log of a job stored in the log storage unit 10 is described, a file of an image log, and the like, and a process of changing (customizing) the path information including the folder name of a folder inside the log server 103 for storing the file of a log. Further, the customizing unit 14 transfers the customization information, such as the customized folder name, the path information, and the file having the customized file name assigned thereto, to the log transmitting unit 3. Alternatively, there may be a mechanism in which the customization information is stored in the customization information holding unit 8 and the log transmitting unit 3 acquires the customization information. The customization instruction information is information for changing the folder name in the log server 103 and the file name to any content desired by the user, and is information for giving an instruction to change the folder name or the file name stored, for example, in the image forming apparatus 100, to any content desired by the user. The customization instruction information is information transmitted from the management tool 101 to the image forming apparatus 100; the customization instruction information is stored in the customization information holding unit 8 via the management tool 101; and the customization instruction information is input to the customizing unit 14 when creating the customization information. The customizing unit 14 functions as an acquiring unit that acquires customization instruction information input by the management tool 101 that is a user terminal.

The replacing unit 6 refers to the customization information (the folder name or the file name after customization) stored in the customization information holding unit 8 and determines whether the number of characters included in the folder name or the file name exceeds a predetermined number of characters (for example, 256 characters). This determination is made because there are restrictions on the folder name and file name that can be handled by the log server 103.

For example, when the number of characters in the customized folder name exceeds the predetermined number of characters, the replacing unit 6 replaces the customized folder name with a folder name set according to a particular rule so that the number of characters in the customized folder name becomes less than or equal to the predetermined number of characters. The particular rule includes, for example, assigning the date and time when the folder name has been customized, assigning only the date when the folder name has been customized, or assigning the user name. Further, the particular rule may be, for example, to delete a particular area of the customized folder name or to partially delete the number of characters in a specific element (e.g., the user name). When the number of characters in the customized file name exceeds the predetermined number of characters, the replacing unit 6 replaces the customized file name with a file name set according to a particular rule so that the number of characters in the customized file name becomes less than or equal to 256 characters. The particular rule includes, for example, assigning the date and time when the file name has been customized, assigning only the date when the file name has been customized, assigning a user name, etc. The particular rule may also be, for example, to delete a particular area of the customized file name.

The folder name or the file name after replacement is stored in the customization information holding unit 8 as the customization information, and is subsequently transmitted to the log server 103 by the customization information transmitting unit 4. When the number of characters in the folder name or the file name does not exceed the predetermined number of characters, the customization information held in the customization information holding unit 8, that is, the folder name or the file name that is not replaced by the replacing unit 6, is transmitted to the log server 103 as the customization information by the customization information transmitting unit 4.

The log server 103 that has received the customization information creates a customized folder based on the customization information, for example, and adds the customized folder to the image log, which will be described later. The log server 103 stores the customized file in the image log based on the customization information. The folder or file, etc., for which the name has been replaced because the number of characters in the customized folder name or file name had exceeded the predetermined number of characters, is added to an error log described later. Accordingly, the customized folder or file, the replaced folder or file, or the like can be easily searched and found by the search tool 102.

The error reporting unit 5 is a reporting unit which reports an error to a report destination (a particular contact) set by the management tool 101, for example, upon detecting that the transmission of the image log and the job log to the log server 103 is unsuccessful. The error reporting may be performed by sending mail in which an error message is described.

The log retransmitting unit 13 is, for example, a retransmitting unit which instructs retransmission when transmission of the image log and the job log to the log server 103 is unsuccessful. The retransmission instruction is to inform the user of a message prompting the user to perform log retransmission. The retransmission instruction is displayed, for example, on a log retransmission screen of the display device 120. For example, when transmission of the image log and the job log to the log server 103 is unsuccessful, the log retransmitting unit 13 may be configured to display, on a log retransmission screen, a message prompting the user to reset the folder name so that the number of characters in the folder name of the folder to be the retransmission destination of the log is less than or equal to the predetermined number of characters.

The error recording unit 12 records the reason of the error in an operation log, for example, when the replacing unit 6 determines that the number of characters in the customized file name or the customized folder name exceeds the predetermined number of characters. By providing the error recording unit 12, even when it is difficult to send a report to a remote location from the error reporting unit 5 due to a communication failure or the like, the recorded operation log can be confirmed to recognize the detailed reason of the error, the date and time when the error has occurred, and so on. Thus, it is possible to flexibly make improvements with respect to the cause of the error. Examples of operation logs are described later.

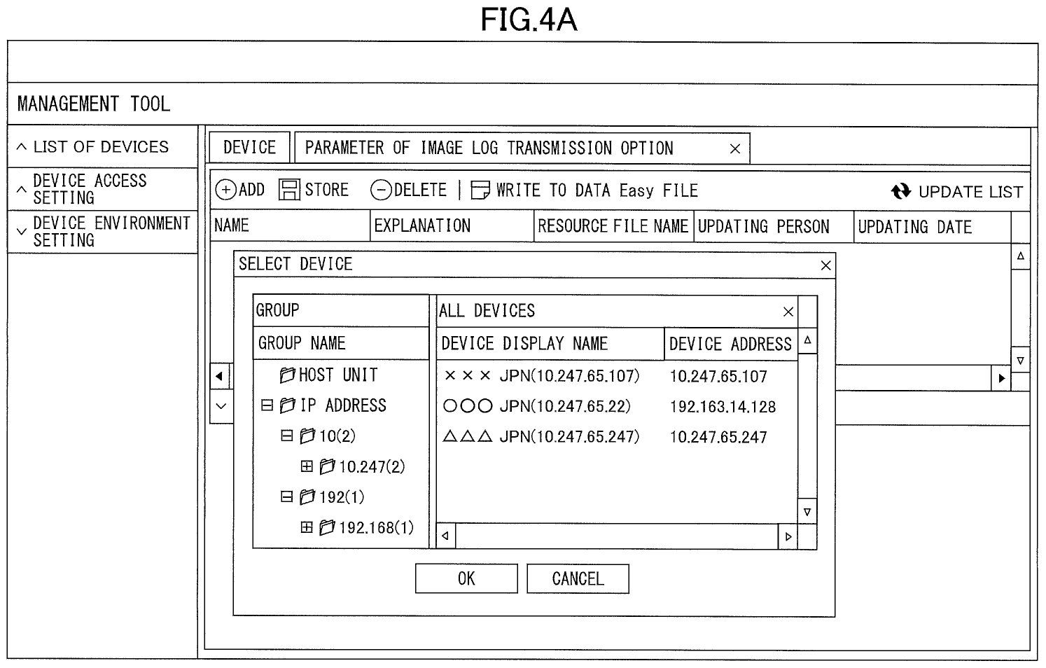

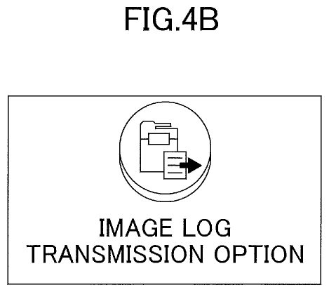

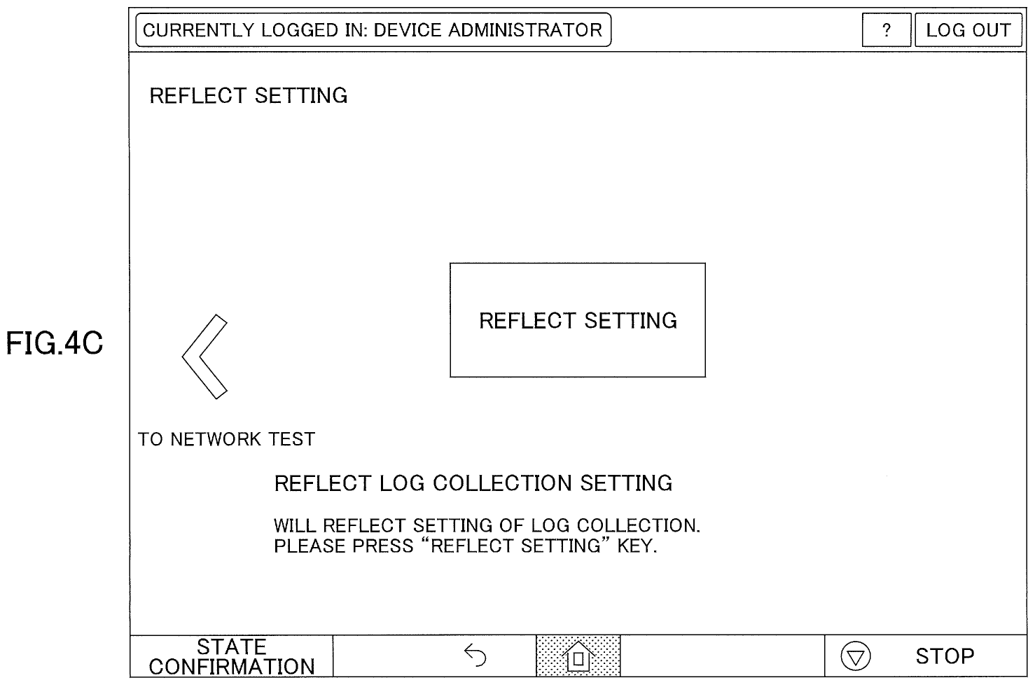

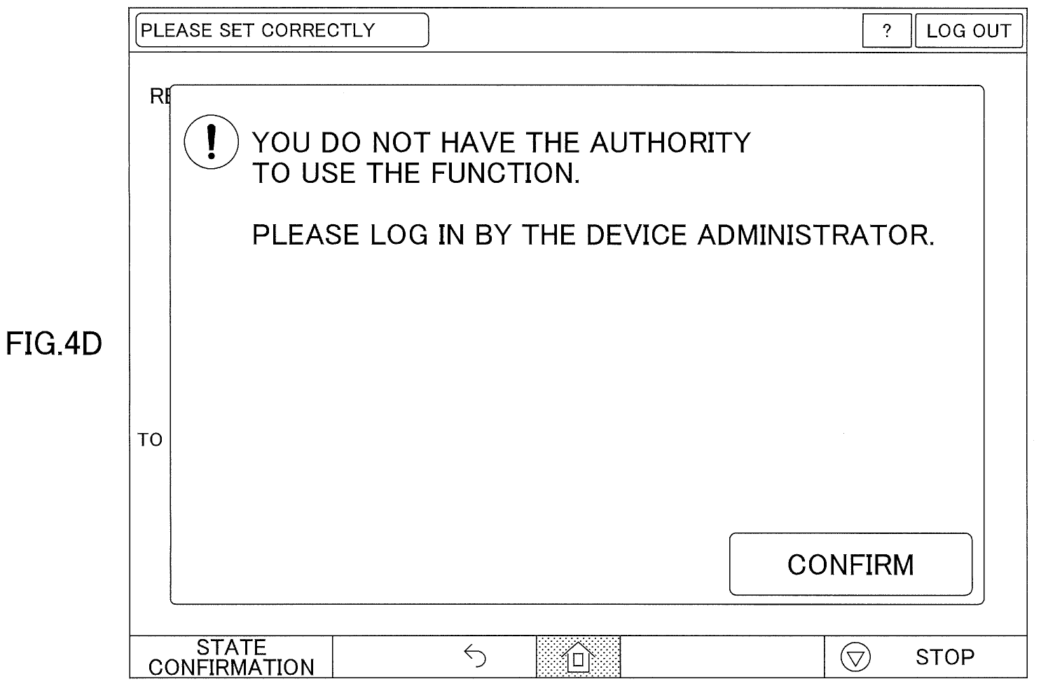

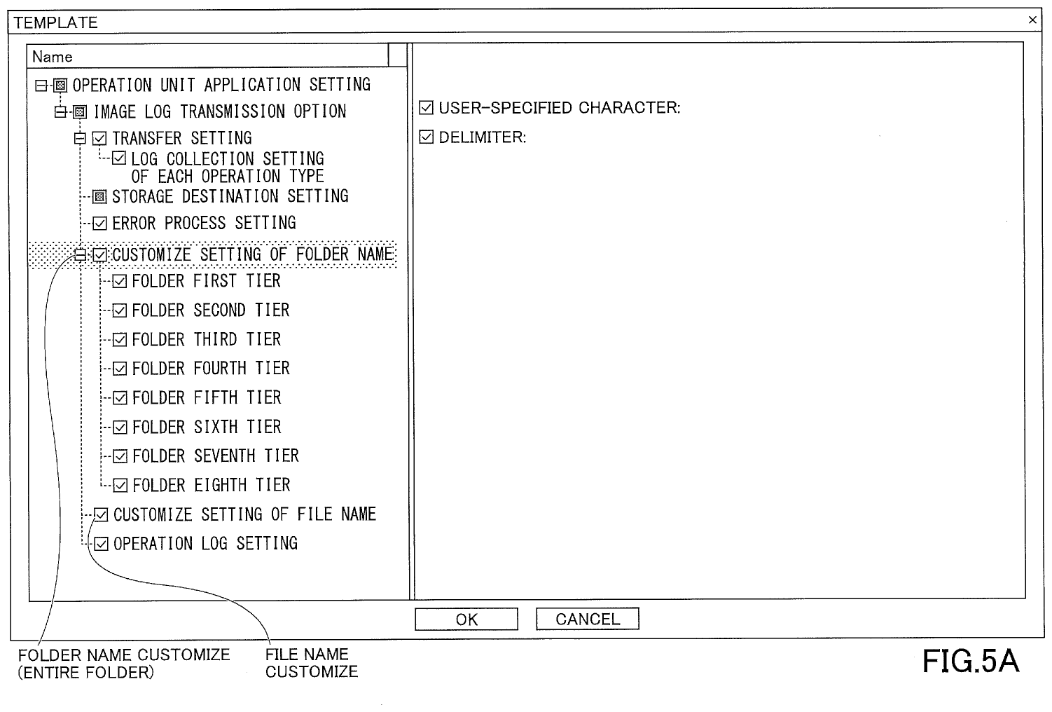

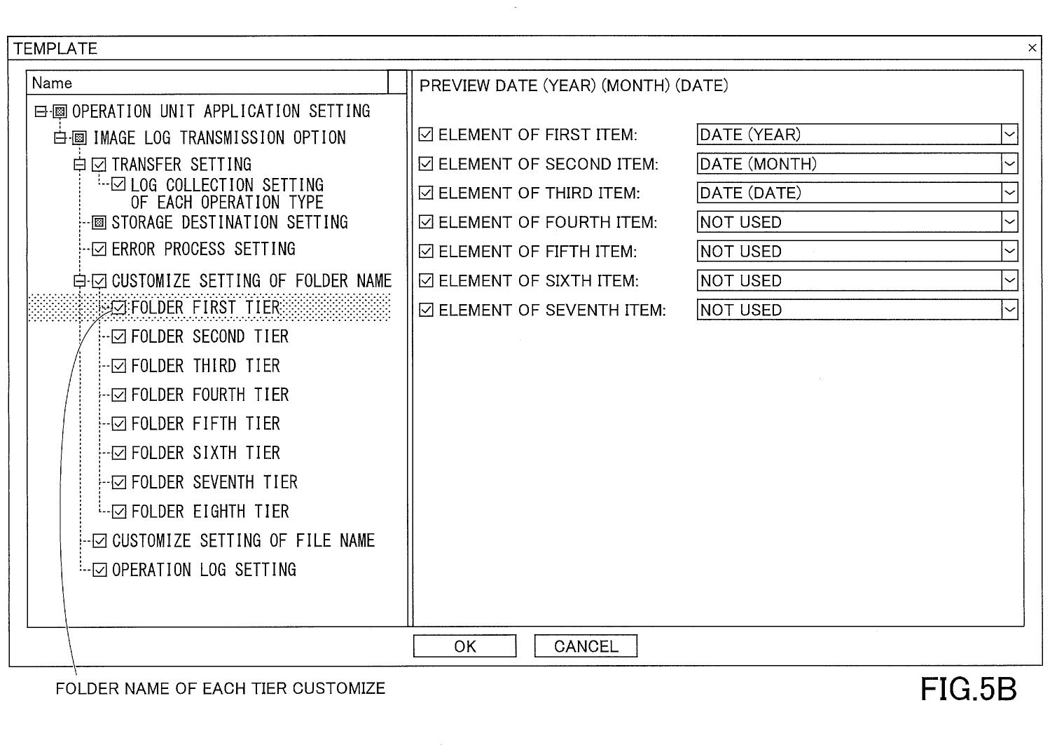

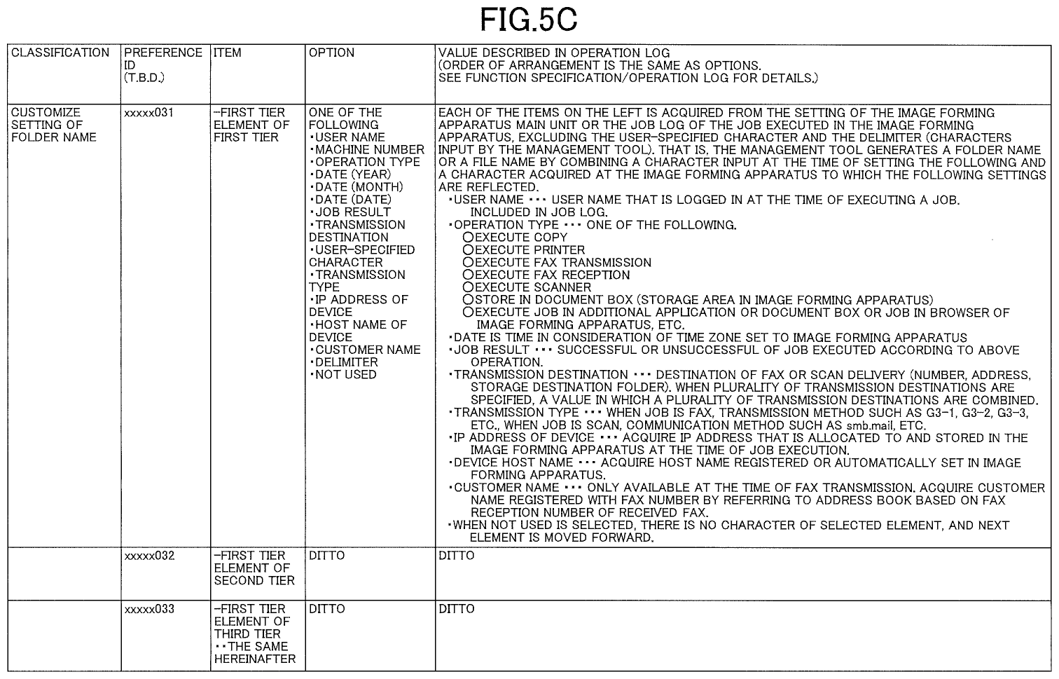

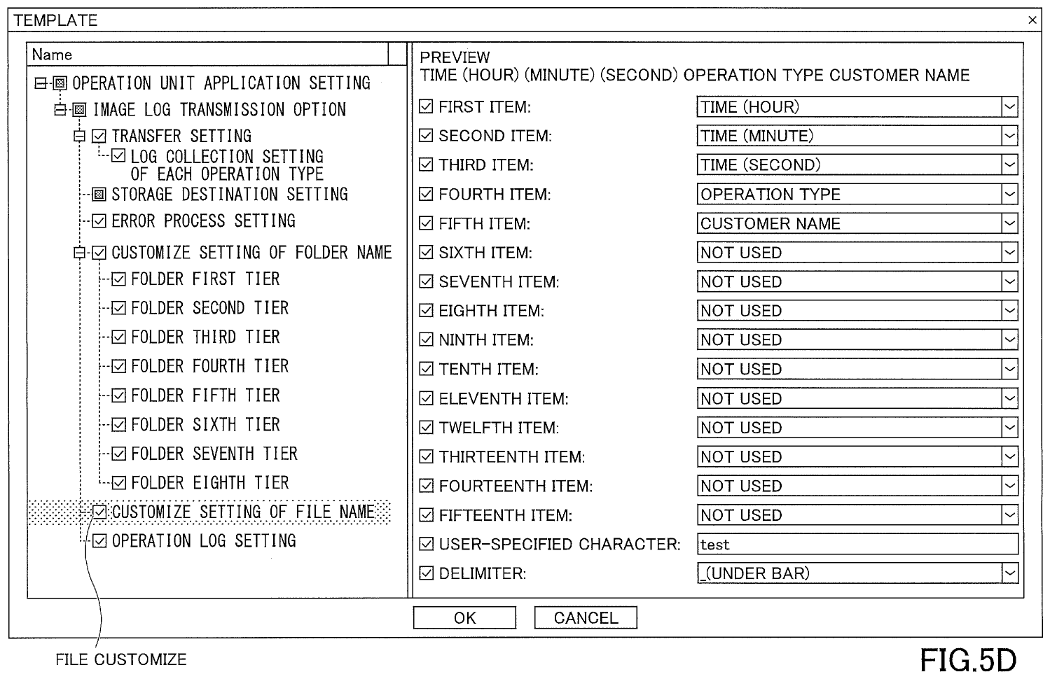

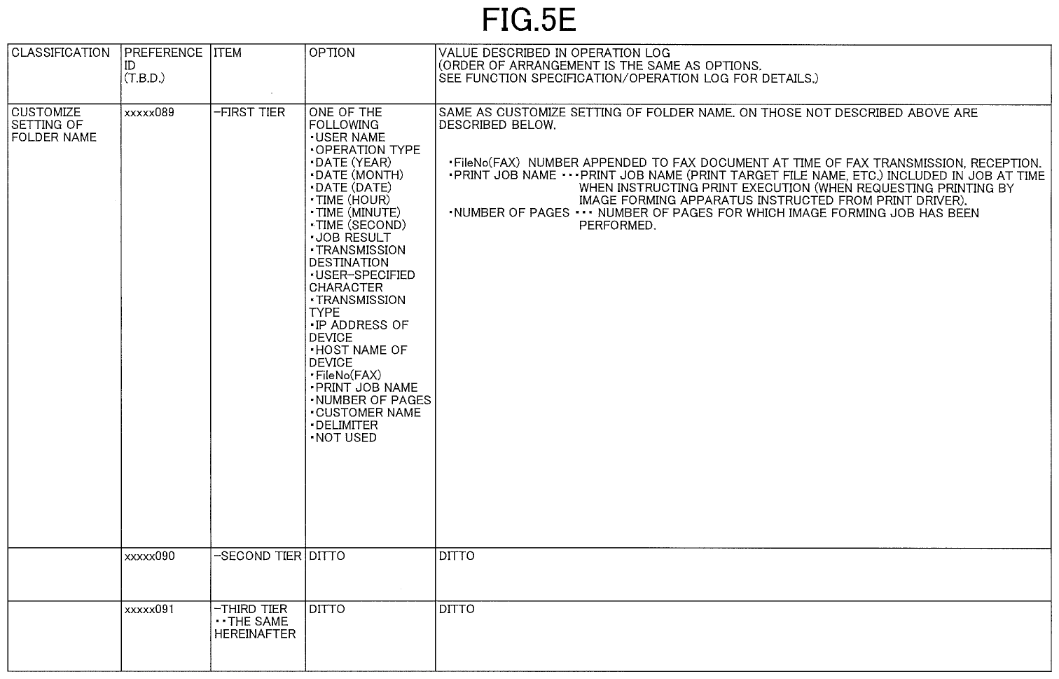

Referring now to FIGS. 4A to 5E, the management tool 101 will be described.

FIG. 4A is a diagram illustrating an example of a screen for selecting a device to be managed by the management tool. In the “device display name” field of the device selection screen of FIG. 4A, a list of the managed devices (management target devices), for example, a plurality of the image forming apparatuses 100 connected to the network 200, is displayed. The management target devices can be collectively set by the user by selecting any of the image forming apparatuses 100 from the “device display name”.

FIG. 4B is a diagram illustrating an example of an icon displayed on the home screen of an operation unit of the image forming apparatus. FIG. 4C is a diagram illustrating an example of a screen for executing the reflecting (applying) of the log collection setting. FIG. 4D illustrates an example of a warning dialog.

For example, when the user logs in to the image forming apparatus 100 from the management tool 101 using the device administrator's ID (identification), the icon as illustrated in FIG. 4B is displayed on the operation unit (the operation input device 140) of the image forming apparatus 100. When the user presses this icon, the screen illustrated in FIG. 4C is displayed. When the user presses the “reflect setting” icon illustrated in FIG. 4C, the setting of the log collection can be reflected (applied). The setting of log collection means to set a folder path in the log server 103 into which the image logs and the like are to be collected (collection destination). Note that when the user has logged in with a number other than the device administrator's ID, a warning dialog as illustrated in FIG. 4D is displayed on the screen of the operation unit of the image forming apparatus 100. The contents of the warning dialog is not limited to the contents of the illustrated example as long as a warning can be made.

FIG. 5A illustrates an example of a screen for customizing a folder. FIG. 5B illustrates an example of a screen for setting the elements of a folder.

The screen illustrated in FIG. 5A is a screen that appears on the monitor of a personal computer (PC) including the management tool 101. For example, eight tiers of folders can be specified, as illustrated on the left of the screen. To customize the folder of the first tier out of the eight tiers, “folder first tier” is specified. Accordingly, as illustrated in FIG. 5B, the screen of the management tool 101 displays element of the first item to the element of the seventh item that can be set to “the folder first tier”. To the right of each of these elements, a pull-down menu for setting the content of each element is displayed.

The element of the first item to the element of the seventh item are information forming one folder name. Thus, for example, seven elements can be set for one folder. The same applies to the folders of the second to eight tiers. These elements are set by selecting any piece of information from the information displayed in the pull-down menu.

Examples of information that can be selected as an element of each item are indicated below.
first tier first item: user name
first tier second item: user-specified character
first tier third item: transmission destination
first tier fourth item: machine number
first tier fifth item: not used
second tier first item: date (year)
second tier second item: delimiter
second tier third item: date (month)
second tier fourth item: date (date)
second tier fifth item: not used

By setting each element as described above, a customized folder can be configured. In this case, the customized folder is configured as “<user name> <user-specified character> <transmission destination> <machine number>/2018_0418/”. This configuration is displayed in the “preview” field of the screen of the management tool 101.

FIG. 5C is a diagram for describing elements that can be set when customizing a folder. Items that can be set by the management tool 101 include the classification of the customization target, the preference ID, the items in each tier, the options, the values described in the operation log, and the like. In FIG. 5C, only the items related to functions related to folder customization among the functions of the management tool 101 are illustrated as examples. “Classification” represents the setting target, and “customize setting of folder name” is displayed in FIG. 5C. “Preference ID” is “xxxx031” and “item” is “element of first tier first item”. Examples of “option” when customizing a folder are the following elements:
User name
Machine number
Operation type
Date (Year)
Date (Month)
Date (Day)
Job result
Transmission destination
User-specified character
Transmission type
IP address of device
Host name of device
Customer Name
Delimiter
Not used

The “values described in operation log” field describes the values of the items indicated in the “option” field. Specifically, the following contents are described. The item value indicated in the “option” field is acquired from the setting item of the image forming apparatus 100 or the job log executed by the image forming apparatus 100, except for the user-specified character and the delimiter (which are input by the management tool 101). That is, the management tool 101 generates a folder name and a file name by combining a character to be input at the time of setting the following and a character acquired by the image forming apparatus 100 to which the following setting is reflected.
User name: User name logged in when the job is executed. Included in a job log.
Operation type: Any one of execute copy, execute printer, execute fax transmission, execute fax reception, execute scanner, store in document box (storage area in the image forming apparatus 100), execute job in additional application or in browser of the image forming apparatus 100, etc.
Date is the time in consideration of the time zone set to the multifunction peripheral (MFP; the image forming apparatus 100).
Job result: Successful or unsuccessful of job executed according to above operation.
Transmission destination: Destination of fax or scan delivery (number, address, storage destination folder). When a plurality of transmission destinations are specified, a value in which a plurality of transmission destinations are combined.
Transmission type: When job is fax, transmission method such as G3-1, G3-2, G3-3, etc., when job is scan, communication method such as smb.mail, etc.
IP address of device: An IP address assigned to the image forming apparatus 100 and stored at the time of execution of the job is acquired. The IP address of the device is information of the setting value set to the image forming apparatus 100. When the information of the setting value is included in the customization instruction information, the image forming apparatus 100 acquires the setting value set at the time of creating or transmitting a log and transmits the acquired setting value to the log server 103 as the customization information.
Device host name: Acquire host name registered or automatically set in the image forming apparatus 100. The setting value information set in the image forming apparatus 100 includes an IP address of the image forming apparatus 100 or a host name set in the image forming apparatus 100. When the IP address or the host name is included in the customization instruction information, the image forming apparatus 100 customizes a folder name or a file name including the IP address or the host name.
Customer name: Only available at the time of fax transmission. Acquire customer name registered with fax number by referring to address book based on fax reception number of received fax.
When not used is selected, there is no character of selected element, and next element is moved up.

Note that when “operation type” of FIG. 5C is selected, a folder corresponding to the job type can be automatically created and the log can be sorted into each folder.

The values of elements other than the following elements are acquired from the job log. However, when the values of the elements other than the following elements cannot be acquired because the job log cannot be referenced, the same operation is performed as when the customization of the folder configuration is not set from the management tool 101.
Machine number
User-specified character
IP address of device
Host name of device
Customer name
Delimiter

The maximum number of characters for each element that can be specified is, for example, 56. When the user-specified character is empty (blank), the corresponding part is ignored. When the above setting example is applied, the <user-specified character> of the second item in the first tier is ignored, and the third item and onward are moved up.

When there is no character string of a value of an element in a job log, or when a particular element is not present in a job log, the corresponding part will be a character string indicating the attribute name of the element. For example, when a job is executed in a state where the transmission destination is specified, the customized folder is configured as “<user name> <user-specified character> desNetAddress <machine number>/2018_0418/”.

FIG. 5D illustrates an example of a screen for customizing a file. To customize a file name, “customize setting of file name” on the left side of the screen is specified. Accordingly, the element of the first item to the element of the fifteenth item that can be set in the file name are displayed on the right side of the screen. To the right of each of these elements, a pull-down menu for setting the content of each element is displayed.

FIG. 5E is a diagram for explaining elements that can be set at the time of file customization. Examples of “option” when customizing a file are the following elements:
User name
Operation type
Date (year)
Date (month)
Date (date)
Time (hour)
Time (minute)
Time (second)
Job result
Transmission destination
User-specified character
Transmission type
IP address of device
Host name of device
File No. (FAX)
Print job name
Number of pages
Customer name
Delimiter
Not used

The “value described in operation log” field describes the values of the items indicated in the “option” field. Specifically, the following descriptions are provided.
File No. (FAX): Number appended to fax document at time of fax transmission and reception.
Print job name: Print job name (print target file name, etc.) included in job at time when instructing print execution (when requesting printing by the image forming apparatus 100 instructed from print driver).
Number of pages: Number of pages for which an image forming job has been performed.

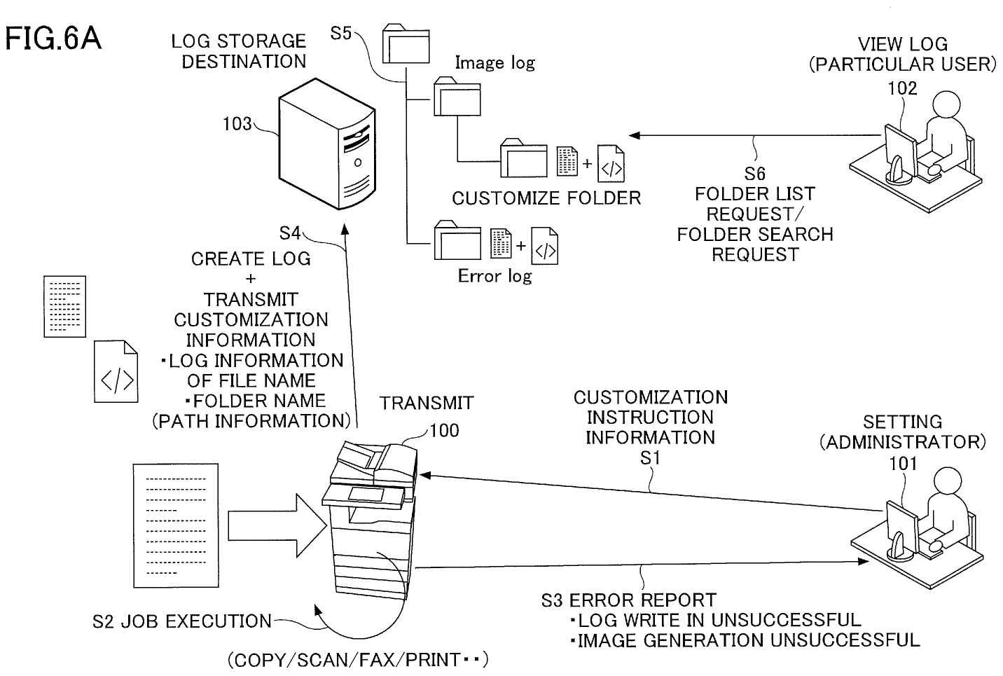

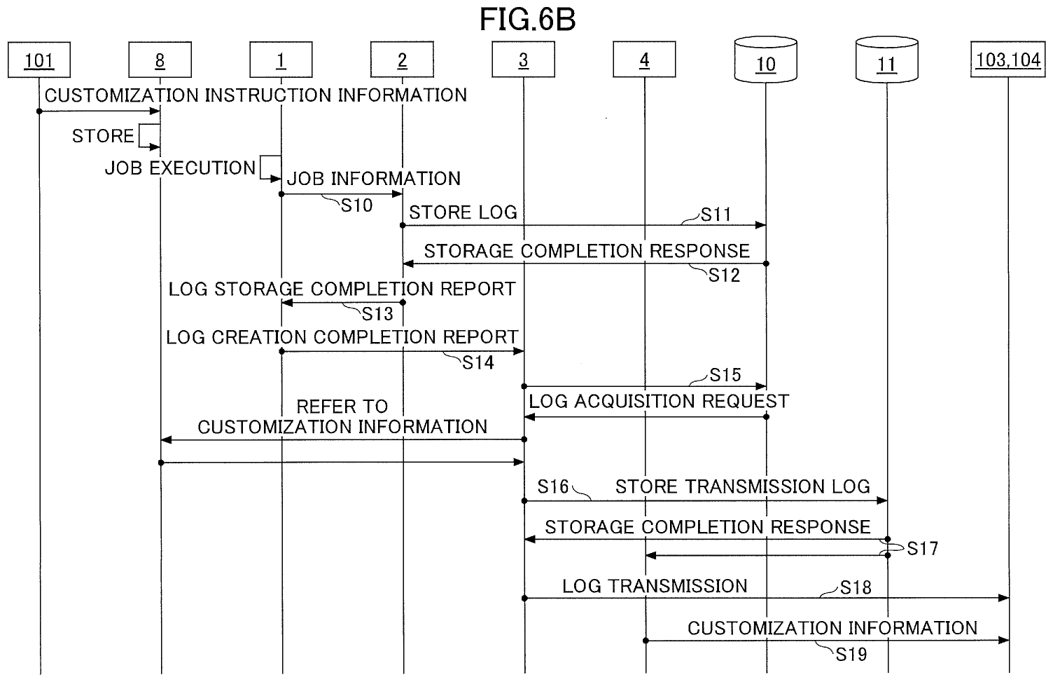

Next, an operation in which the customized folder name and file name and the like are reflected (applied) to the log server 103 will be described with reference to FIG. 6A and the like.

FIG. 6A is a diagram for explaining an operation of the information processing system at the time of log transmission. In step S1, for example, when the administrator executes the customization of the folder name and the file name of a job by using the management tool 101, the content of the customized folder name and file name are transmitted as customization instruction information to the image forming apparatus 100 to be stored therein. As described above, the management tool 101 instructs the image forming apparatus 100 to change the setting of the folder path and the file path in order to customize the folder name and the file name.

In step S2, various jobs such as copying, scanning, fax transmitting, and printing are executed in the image forming apparatus 100. At this time, for example, when writing of a log is unsuccessful or image generation is unsuccessful, in step S3, the image forming apparatus 100 reports an error to the management tool 101.

In step S4, the image forming apparatus 100 creates a log corresponding to the type of the job and transmits the aforementioned customization information (including the log information of the file name and the folder name (path information)) to the log server 103.

Details of the operation in step S4 will be described with reference to FIG. 6B. FIG. 6B is a sequence chart illustrating an operation of the image forming apparatus 100.

As a prerequisite for the sequence, the image forming apparatus 100 first stores the customization instruction information acquired from the management tool 101 in the customization information holding unit 8, and creates job information when various image forming jobs (print, scan, copy, fax, and the like) are executed by the image forming apparatus 100. In step S10, the job information creating unit 1 creates the job information and transmits the job information to the log creating unit 2.

In step S11, the log creating unit 2 that has received the job information creates a log corresponding to the type of the job and stores the created log in the log storage unit 10.

In step S12, when the log creating unit 2 receives a storage completion response indicating the completion of the log storage from the log storage unit 10, in step S13, the log creating unit 2 transmits a log storage completion report indicating the completion of the log storage to the job information creating unit 1.

In step S14, the job information creating unit 1 that has received the log storage completion report transmits a log creation completion report indicating that the log creation is completed to the log transmitting unit 3.

In step S15, the log transmitting unit 3 that has received the log creation completion report acquires the log stored in the log storage unit 10 by transmitting a log acquisition request to the log storage unit 10.

In step S16, the log transmitting unit 3 that has acquired the log stored in the log storage unit 10 creates a transmission log (log information) that is a log to be transmitted to the log server 103 and stores the created transmission log in the transmission log storage unit 11. Specifically, the log transmitting unit 3 customizes the file name (change based on the referenced customization information) and sets the log file format to enable storage in the log server 103 and converts the log file format into a pdf format so to be referred from outside, and stores the transmission log.

In step S17, the log transmitting unit 3 and the customization information transmitting unit 4 receive a storage completion response indicating the storage completion of the transmission log from the transmission log storage unit 11.

In step S18, the log transmitting unit 3 that has received the storage completion response transmits the log information to the log server 103, and in step S19, the customization information transmitting unit 4 that has received the storage completion response reads the customization information held in the customization information holding unit 8 and transmits the customization information to the log server 103. At the time of this log transmission (storage in the folder of the server), the log transmitting unit 3 confirms whether a folder having the name included in the customization information exists in the log server 103 that is the transmission destination. When such a folder does not exist, the log transmitting unit 3 newly creates a folder having the customized name in the log server 103 and stores the log file in the created folder.

Returning to FIG. 6A, in step S5, when the customization information includes a new folder name, that is, when it is determined that a folder name that does not exist in the log server 103 is included in the customization information, the log server 103, which has received the log information and the customization information, creates a new folder according to the received customization information and stores the log in the created folder.

On the other hand, when the customization information does not include a new folder name that does not exist in the log server 103, or when the customization information includes a folder name that is the same as a folder name that already exists in the log server 103, the log server 103 stores the log (image log) in the already existing folder without creating a new folder.

In step S6, the log stored in the log server 103 is searched and viewed by using the search tool 102.

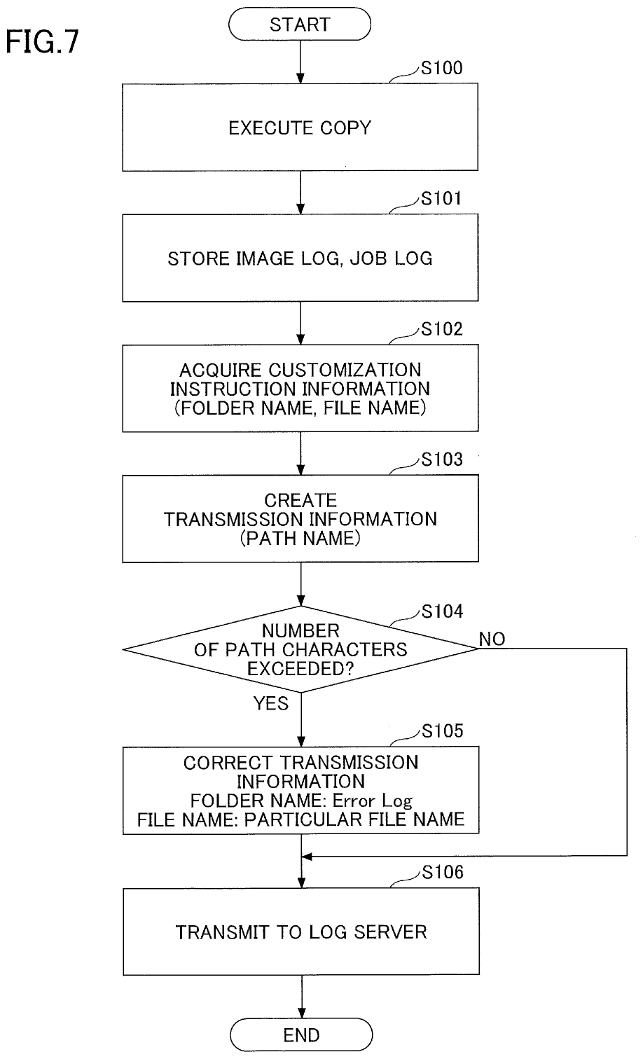

Next, the operation of each function of the image forming apparatus 100 will be described with reference to FIGS. 7 to 15.

FIG. 7 is a first flowchart explaining a character number determination operation. For example, copying is executed in step S100, and an image log, a job log, or the like is stored in step S101. In step S102, customization instruction information is acquired, and in step S103, information to be transmitted (path name) to the log server 103 is created based on the customization instruction information. In step S104, it is determined whether the number of characters in the path name exceeds a predetermined number of characters, and when the number of characters exceeds the predetermined number of characters, the process in step S105 is executed. When the number of characters does not exceed the predetermined number of characters, the process in step S106 is executed. In step S105, for example, when the path name of the transmission destination exceeds the predetermined number of characters, the path name becomes Error Log. Further, the file name will be fixed to machine number_log ID. In step S106, the information is transmitted to the log server 103.

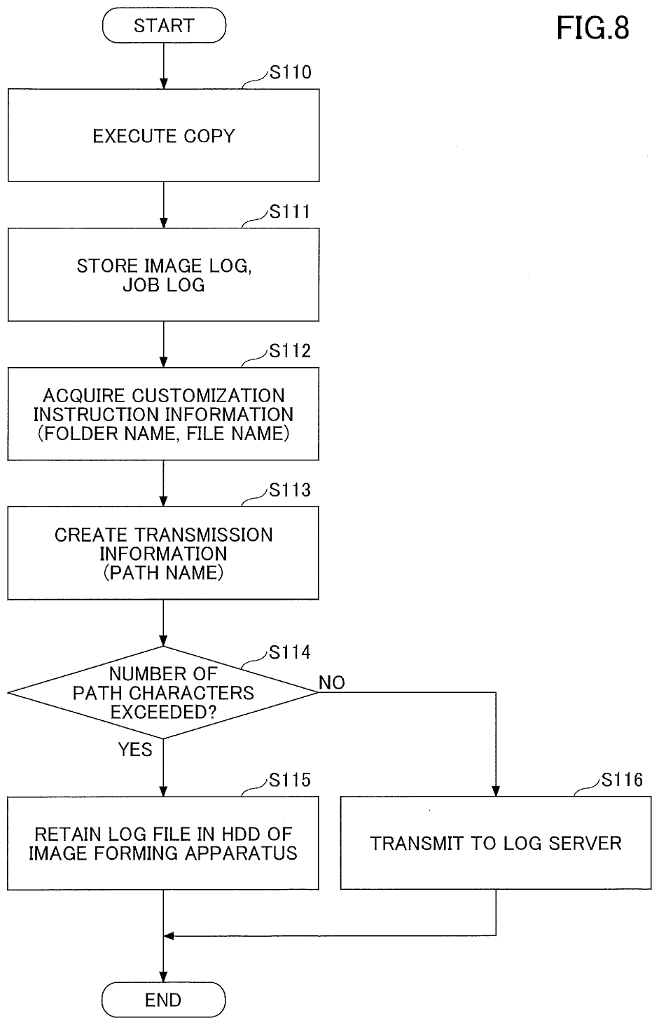

FIG. 8 is a second flowchart explaining a character number determination operation. The processes in step S110 to step S114 and step S116 are similar to the processes in step S100 to step S104 and step S106 in FIG. 7. When the number of characters exceeds the predetermined number of characters, the process in step S115 is executed. In step S115, for example, a process of leaving the file with the exceeding number of characters (a process to retain the file) in the hard disk drive of the image forming apparatus 100 and the like is performed. This allows an administrator or a service person who is a Customer Engineer (CE) of the file with the exceeding number of characters to read the file by using an exclusive-use tool.

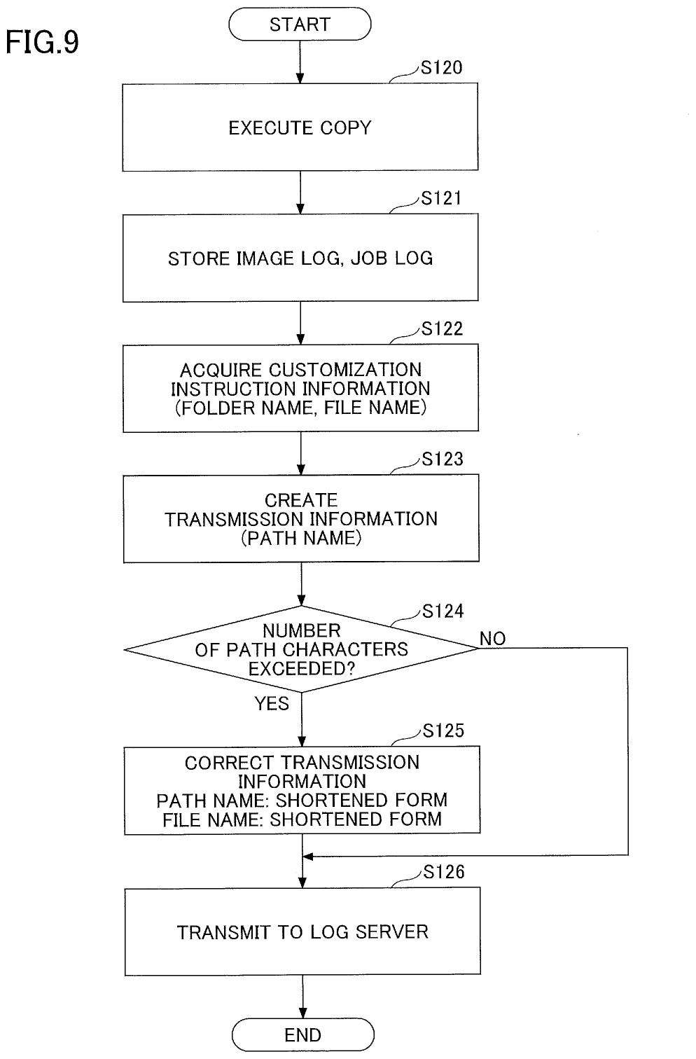

FIG. 9 is a third flowchart explaining a character number determination operation. The processes in step S120 to step S124 and step S126 are similar to the processes in step S100 to step S104 and step S106 in FIG. 7.

When the number of characters exceeds the predetermined number of characters, the process in step S125 is executed. In step S125, the path is replaced with a shortened path according to the particular rule described above. Examples of a path before the replacement and a path after the replacement are as follows.
Path before shortening: <Primary Storage Path>/ImageLog/Mr. A_xxxx (300 characters)/<Machine Number>_<Log ID>.xml
Path after shortening: <Primary Storage Path>/ImageLog/Mr. A_xxxx (100 characters)/<Machine No.>_<Log ID>.xml

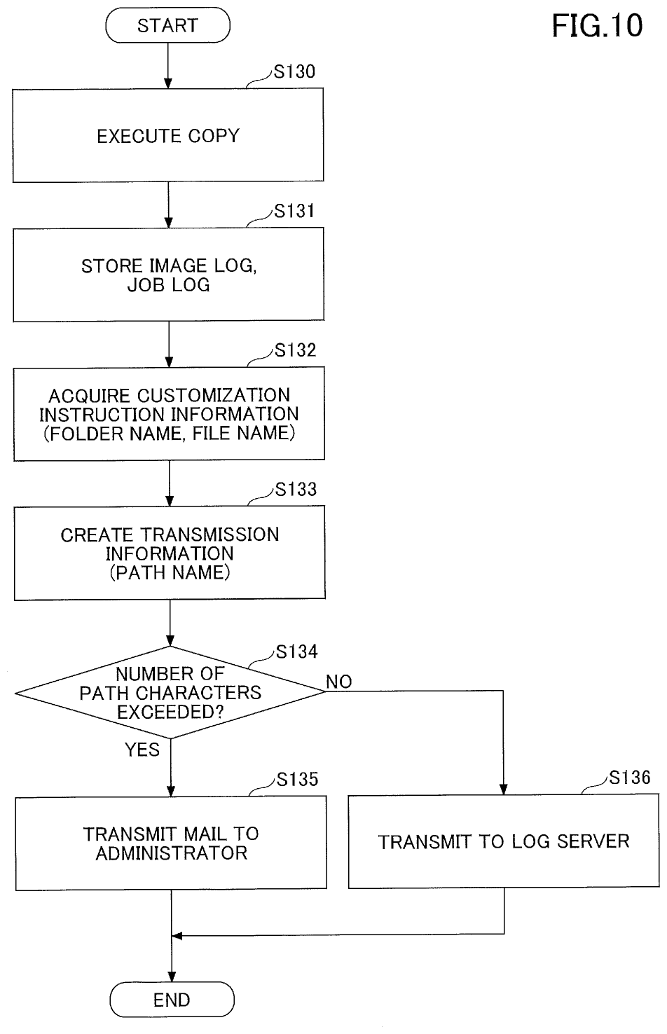

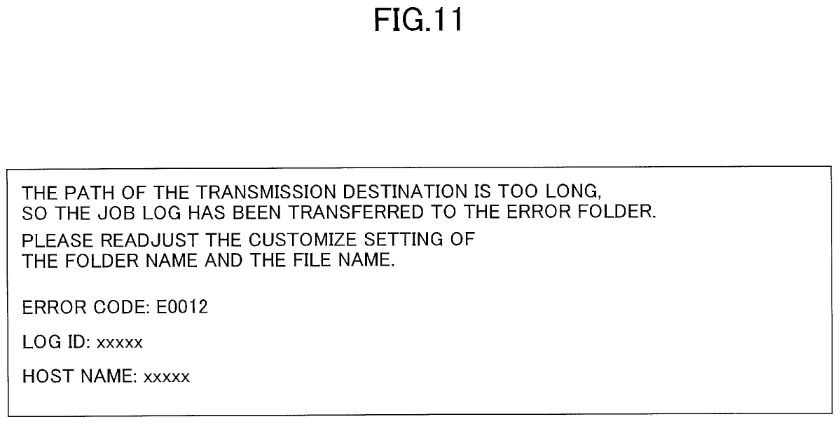

FIG. 10 is a fourth flowchart explaining a character number determination operation. The processes in step S130 to step S134 and step S136 are similar to the processes in step S100 to step S104 and step S106 in FIG. 7. When the number of characters exceeds the predetermined number of characters, the process in step S135 is executed. In step S135, a process of reporting the error content to the registered mail address of the administrator is performed. A specific example will be described with reference to FIG. 11.

FIG. 11 is a diagram illustrating the content of the report mail. For example, when the number of characters exceeds the predetermined number of characters, the error reporting unit 5 of the image forming apparatus 100 transmits the report mail illustrated in FIG. 11 to the management tool 101. The report mail includes a message explaining the outline of the error content, and also an error code, a log ID, a host name, etc. The error code is the identification number of the error content. The log ID is the identification number of the log in which the error has occurred. The host name is the name of the device in which the error has occurred, for example, the model name of the image forming apparatus 100. Accordingly, the administrator who has confirmed the error content can readjust the customization content and operation.

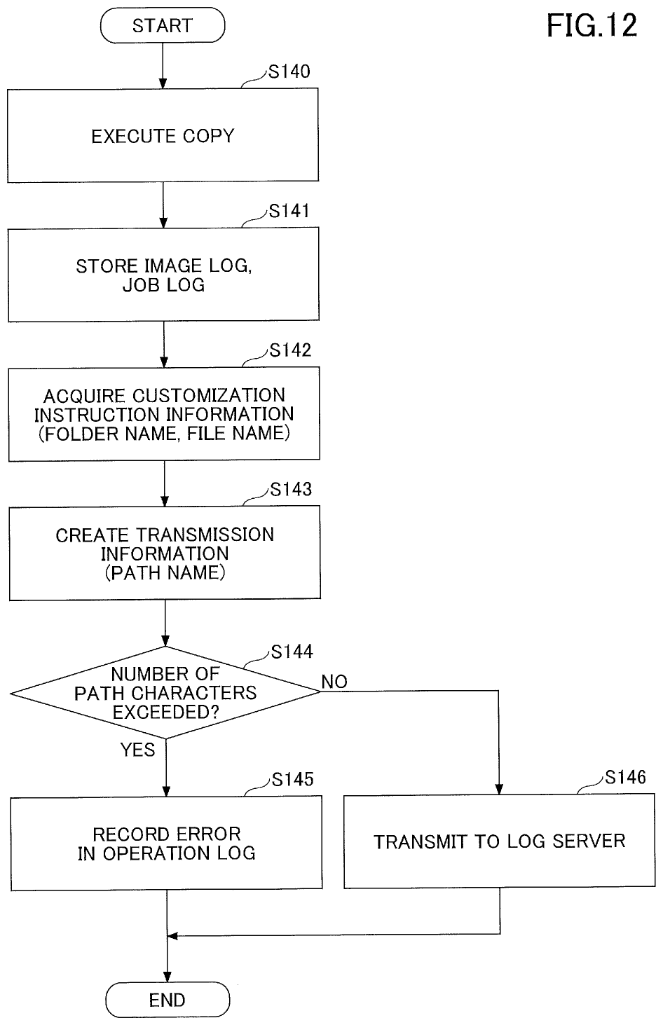

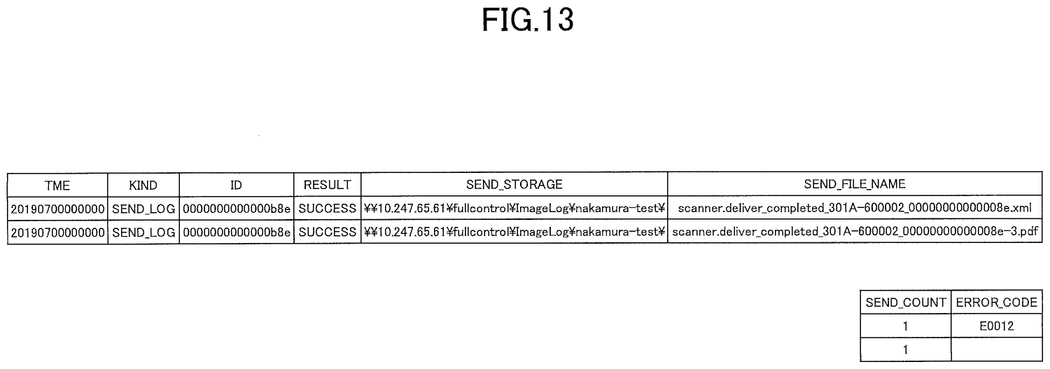

FIG. 12 is a fifth flowchart explaining a character number determination operation. The processes in step S140 to step S144 and step S146 are similar to the processes in step S100 to step S104 and step S106 in FIG. 7. When the number of characters exceeds the predetermined number of characters, the process in step S145 is executed. In step S145, a process of recording an error in an operation log is performed. A specific example will be described with reference to FIG. 13.

FIG. 13 is a diagram illustrating an example of an operation log. The operation log is one of the logs stored in the image forming apparatus 100 every time the log transmitting unit 3 transmits log information. The operation log includes the date and time the log has been generated, the log type, the log ID, the transmission result, the path name, the file name, the number of times of transmission, an error code, and the like. The error recording unit 12 is, for example, a recording unit that records the reason of the error (for example, “exceeding the number of characters”) in the operation log when the number of characters in the customized file name or folder name exceeds the predetermined number of characters. Accordingly, the administrator can confirm the operation log and readjust customization settings.

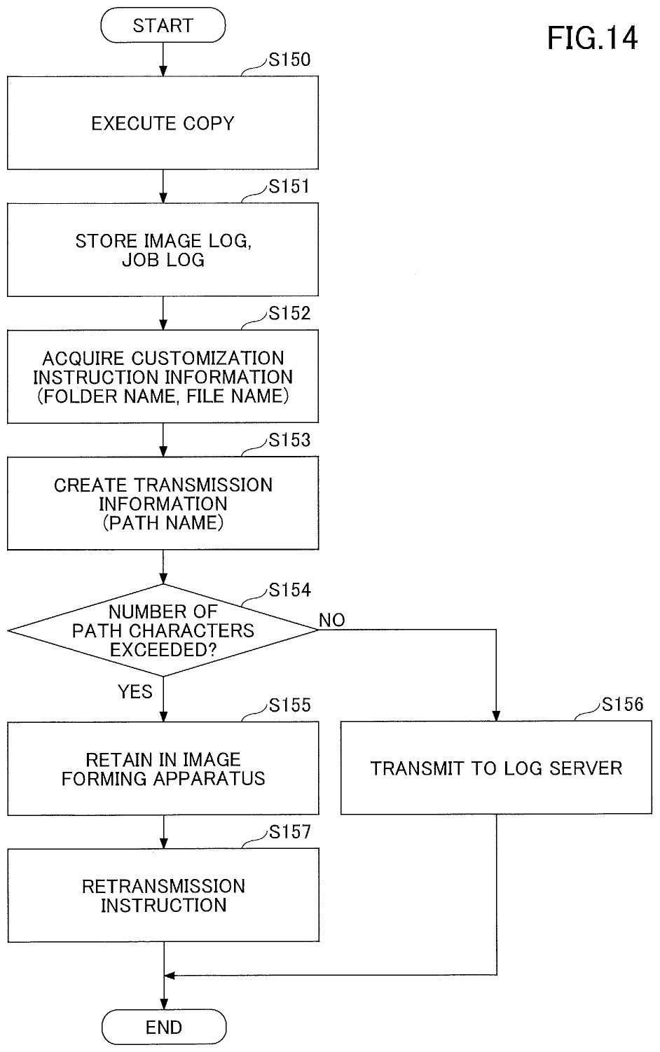

FIG. 14 is a sixth flowchart illustrating a character number determination operation. The processes in step S150 to step S154 and step S156 are similar to the processes in step S100 to step S104 and step S106 in FIG. 7.

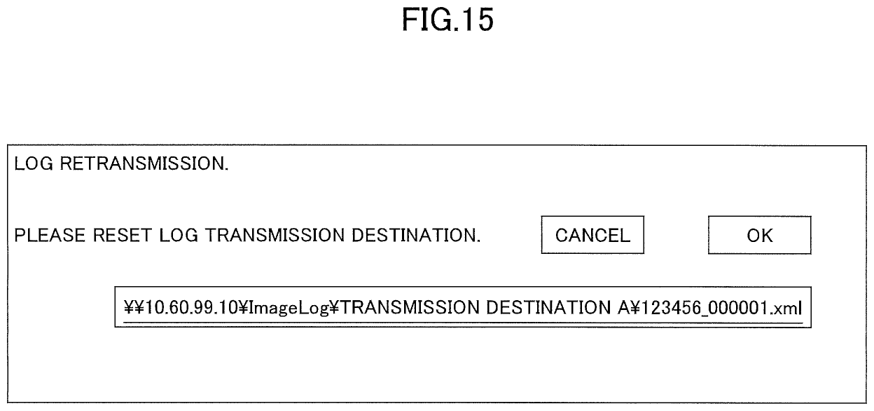

When the number of characters exceeds the predetermined number of characters, the process in step S155 is executed. In step S155, for example, a process (process for retaining) is performed in which the file having an exceeding the number of characters is left in the hard disk drive of the MFP (the image forming apparatus 100). In step S157, a retransmission instruction is given to the user. Referring to FIG. 15, a specific example of a retransmission instruction will be described.

FIG. 15 is a diagram illustrating an example of a log retransmission screen. For example, when the user resets the log transmission destination (the folder name and the like) on the log retransmission screen of the display device 120, the image log and the job log retained in the image forming apparatus 100 can be transmitted. Accordingly, even when there is an image log or a job log that has an exceeding number of characters and that is retained in the image forming apparatus 100, the user can specify the retained log and modify the customized folder name and file name and transmit the log.

When an instruction is included in the customization instruction information to acquire the job type representing the type of the job executed by the image forming apparatus 100 and set the acquired job type as the customization information, the customizing unit 14 of the image forming apparatus 100 may be configured to acquire the job type from the information of the job that is the target of being logged and transmit the job type as the customization information to the log server 103. The “job type representing the type of the job executed by the image forming apparatus 100” indicates the job type specified by the management tool 101. The “instruction to acquire the job type and set the job type as the customization information” is to instruct the acquisition of the job type specified by the management tool 101. “Job type from information of job that is the target of being logged” indicates specific job type information (printing, scanning, etc.) included in the created job information (bibliographic information).

The image forming apparatus 100 may be configured to customize a file including the log information created as a result of the job execution based on the customization instruction information that is acquired, to have a file name included in the customization instruction information, and cause the server to create, in the server, a folder in which the file is to be stored, when transmitting the file including the log information to the log server 103, with a folder name based on the customization instruction information.

According to one embodiment of the present invention, the operability when searching for a log, can be improved.

The image forming apparatus and the recording medium are not limited to the specific embodiments described in the detailed description, and variations and modifications may be made without departing from the spirit and scope of the present invention.

What is claimed is:

1. An image forming apparatus comprising:
processing circuitry; and
a memory storing computer-executable instructions that cause the processing circuitry to:
transmit, to a server, log information that represents a content of a log that is created according to a job type of a job of the image processing apparatus; and
transmit, to the server, customization information obtained by customizing a folder name of a folder included in the server that is a storage destination of the log information or by customizing a file name of a file including the log information, the folder name or the file name being customized based on customization instruction information that represents an instruction to customize the folder name or the file name.

2. The image forming apparatus according to claim 1, wherein the processing circuitry is further caused to:
replace the customized folder name or the customized file name with a folder name or a file name including a number of characters that is less than or equal to a predetermined number of characters, and transmit the folder name or the file name after replacement to the server, upon determining that a number of characters included in the customized folder name or the customized file name exceeds the predetermined number of characters.

3. The image forming apparatus according to claim 2, wherein the processing circuitry is further caused to:
replace the customized folder name or the customized file name with a folder name or a file name that is set according to a predetermined rule.

4. The image forming apparatus according to claim 1, wherein the processing circuitry is further caused to:
report, to a particular report destination, that a number of characters in the customized folder name or the customized file name exceeds a predetermined number of characters, upon determining that the number of characters in the customized folder name or the customized file name exceeds the predetermined number of characters.

5. The image forming apparatus according to claim 1, wherein the processing circuitry is further caused to:
record a reason why a number of characters in the customized folder name or the customized file name exceeds a predetermined number of characters, in an operation log that is created when operating the image forming apparatus, upon determining that the number of characters in the customized folder name or the customized file name exceeds the predetermined number of characters.

6. The image forming apparatus according to claim 1, wherein the processing circuitry is further caused to:
give an instruction to prompt a user to retransmit a folder name or a file name obtained by reducing a number of characters included in the customized folder name or the customized file name, upon determining that the number of characters in the customized folder name or the customized file name exceeds a predetermined number of characters.

7. The image forming apparatus according to claim 1, wherein the processing circuitry is further caused to:
transmit, to the server as the customization information, the customized folder name or the customized file name that is customized based on the customization instruction information, upon determining that a number of characters included in the customized folder name or the customized file name does not exceed a predetermined number of characters.

8. The image forming apparatus according to claim 1, wherein the processing circuitry is further caused to:
acquire the customization instruction information that is input at a user terminal.

9. The image forming apparatus according to claim 1, wherein the processing circuitry is further caused to:
acquire a setting value, which is information set in the image forming apparatus, when creating or transmitting the log, and transmit the acquired setting value as the customization information to the server, upon determining that the customization instruction information includes the information representing the setting value.

10. The image forming apparatus according to claim 9, wherein
the information of the setting value set in the image forming apparatus includes an Internet Protocol (IP) address of the image forming apparatus or a host name set in the image forming apparatus, and wherein the processing circuitry is further caused to:
customize the folder name or the file name to include the IP address or the host name, upon determining that the customization instruction information includes the IP address or the host name.

11. The image forming apparatus according to claim 1, wherein the processing circuitry is further caused to:
acquire the job type from information of the job that is a target of the log, and transmit the acquired job type as the customization information to the server, upon determining that the customization instruction information includes an instruction to acquire the job type of the job to be executed by the image forming apparatus and to set the acquired job type as the customization information.

12. The image forming apparatus according to claim 7, wherein the processing circuitry is further caused to:
customize the file name of the file including the log information created as a result of executing the job, to be a file name included in the customization instruction information, based on the customization instruction information that is acquired, and
cause the server to create, in the server, the folder in which the file is to be stored, with a folder name based on the customization instruction information, when transmitting the file including the log information to the server.

13. A non-transitory computer-readable recording medium storing a program that causes a computer to execute a process performed in an image forming apparatus, the process comprising:
transmitting, to a server, log information that represents a content of a log that is created according to a job type of a job of the image processing apparatus; and
transmitting, to the server, customization information obtained by customizing a folder name of a folder included in the server that is a storage destination of the log information or by customizing a file name of a file including the log information, the folder name or the file name being customized based on customization instruction information that represents an instruction to customize the folder name or the file name.
